(19) United States
(12) Patent Application Publication
(10) Pub. No.: US 2008/0140569 A1
(43) Pub. Date: Jun. 12, 2008

(54) Method, System, and Apparatus for Approval of an e-Commerce Transaction, using One or More Approving Agents

(76) Inventor: David Brian Handel, Galloway, NJ (US)

Correspondence Address: MAXVALUEIP CONSULTING, 11204 ALBERMYRTLE ROAD, POTOMAC, MD, 20854, US

(21) Appl. No.: 11/609,345

(22) Filed: Dec. 12, 2006

(51) Int. Cl. G06Q 40/00; G06Q 30/00; H04L 9/00

(52) U.S. Cl. 705/44; 705/26; 705/64

(57) ABSTRACT

In one of the examples of current application, the general business process described here requires utilization of a third party to approve an e-commerce transaction, before it can be finalized. Most typically, the third party, hereinafter called the authorizer or approver is a parent or legal guardian of the person, hereinafter called the purchaser or user, attempting the purchase transaction. The authorizer may have a number of other possible relationships to the purchaser, such as being a friend, relative of any type, such as a spouse, a trustee, a person with power of attorney, or anyone the purchaser voluntarily elects to serve in that role. The authorizer (in many cases) will be someone legally required to be involved in order to give the purchaser the ability to make a purchase or make important decisions on Internet. In other situations, the election of having an authorizer (be involved with the account, or in an ad hoc transaction) is simply at the request of the purchaser.

### BACKGROUND

U.S. Pat. No. 6,173,269 (Solokl et al.) teaches a method of executing electronic commercial transactions with minors. Other examples of prior art are: U.S. Pat. No. 7,146,328 (Rebates processing), U.S. Pat. No. 7,138,914 (Tracking services), and U.S. Pat. No. 7,134,131 (Process billing). However, these models are different from ours, and our system has not been taught, yet.

### SUMMARY

In this disclosure, in one embodiment, we have developed a web site, which is a monthly subscription ASP (Application Service Provider) model site whose purpose is to offer a set of useful tools for those with declining memory (or anyone who wants some help with his/her memory). The software tools on the site are designed to help these people and their caretakers/family members organize their lives and make their days easier to manage. Included in that embodiment was a method for memory impaired seniors to make online purchases that would require electronic approval by a responsible caretaker or sub-user before the purchase could be finally executed. The purpose of this method is to prevent the memory impaired individual from making purchases that are not in their best interests.

In general, in another embodiment, the subscription can be done daily, per-usage, yearly, flat-fee, or for free. The web site can be generalized as a broadcasting center (or webcasting or multicasting system), with or without any focused audience, such as paid members or certain age groups.

In one embodiment, a web site has an e-commerce store doing any transaction, such as selling, renting, leasing, using, or performing, on any (different) goods, items, and services, tangible or intangible, such as furniture, appliances, music, books, movies, toys, opera tickets, sport event tickets, attorney pre-paid services, CPA pre-paid services, investment advice, stock purchase, or future stocks, items, contracts, or guarantees. The items could be in digital or analog form. They could be tangible or intangible. One can apply Digital Rights Management (DRM) and encryption to safe-guard and keep track of the ownership, assignment, trail audit, and usage, for example, for marketing, research, resource allocations, and accounting purposes.

In one embodiment, some of the “patients” (or subscribers, users, or consumers) may wish to assign a “power of attorney” to a caretaker, guardian, approver, parents, older brother, judge, attorney, or a trusted family member, concerning their activities within the e-commerce store (or even within other areas of the site). Thus, the site allows subscribers or users to have “sub-users”, who are caretakers, family members, friends, or advisors, to whom the subscriber can assign certain privileges, rights, or authorities. Concerning their activities within the store, a subscriber who might be underage or be of legal age but have impaired judgment with for instance mild Alzheimer's disease might decide, or the website itself may have a rule or requirement that one of their sub-users or guardians approve a purchase prior to its final submission. In the case of our web site, that sub-user is sent an email and/or an SMS (or a signal on a pager, a text message on a cell phone, a message on the screen of a PC, a printout from a printer, a connection to the ADT security alarm system, calling 10 different telephone numbers sequentially, or any other method of notification or alarming a user), alerting them that they need to go to the site, log-in (manually or automatically), review the contents of the subscriber's shopping cart, and approve/disapprove the purchase.

### BRIEF DESCRIPTION OF THE DRAWINGS

FIG. 1 shows a block diagram of a typical system (one embodiment/example).

FIG. 2 shows a typical flow diagram of the typical method or process (one embodiment/example).

### DETAILED DESCRIPTION OF THE PREFERRED EMBODIMENTS

In one embodiment, the process of the current invention can be done without the interaction of the sub-user. For example, the sub-user's computer, cell phone, BlackBerry, or PDA can be automatically connected to a specific server, web site, or another computer, cell phone, BlackBerry, or PDA. Alternatively, the data can be downloaded or uploaded automatically (or with minimum interaction from sub-user) to the sub-user's device, directly or indirectly (for example, through a for-profit or non-profit organization, providing such a service).

In one embodiment, the e-Commerce shopping cart can be in multiple places, as a distributed entity, and the system aggregates for multiple web sites, as well as for multiple users and/or multiple sub-users, based on the default of the system or the preference of the users and/or sub-users. The shopping cart can be a hierarchical structure. For example, the grocery is in one category, and the books are in another category. This way, the management and assignment of the authority, plus levels of security, can be customized based on each category. For example, buying grocery may need no approval, buying books less than 100 dollars may need 1 approval, buying books with adult subjects may need 2 adult approvals, one with an age over 30, or buying the rare books with value over 100,000 dollars may need the court-appointed legal guardian's approval.

In one embodiment, the approvals and credentials are done within a trusted system, which can have its own hierarchy. Some entity with a higher credentials can approve or authenticate some entity lower than itself, as long as some tests or conditions are approved or satisfied. Certificates (or certificates within certificates) (that is, digital certificates, throughout this disclosure) can be issued. One entity can approve another at different trust levels, depending on the degree of certainty or trust. The certainty can be dependent on the degrees of separation or mutual acquaintances between different entities.

In one embodiment, the authorities can have position or context-based certificates. For example, one can replace the guardian of a minor child, and still use the same certificates and authorities. One or more certificates can be issued to an entity, for different purposes. There may be a central database or registry storing all the certificates, identities, real names, authentication rules, authority levels, security levels, limitations on web searches, limitations on web site access, or limitations on dollar amount spending (as a total value, per day, per item, per class, per web site, or per user). There is also a mechanism/module for storing new authorities, deleting the expired or cancelled authorities, or registering new users. There may be a review process for each application for new entry. There is also an arbitration engine resolving conflicts based on human judgment and/or computer, using rule-based decision engine using different parameters, such as age of the parties or authority levels, as well as fuzzy logic, to compare or quantify some of the parameters and conditions.

In one embodiment, the guardian or approver can be one or more entities. The approver can have another approver approving him/her. This can be hierarchical and in multiple steps (tree structure). In one embodiment, the assignor assigns a user and one or more approvers, assigned to the user. For every user-approver pair, one has a set of conditions, rules, authorities, limitations, for a duration of time (or periodic intervals), and their identities. There is an accepted (minimum standard) method of authentication for the system, for a given security level.

In one embodiment, the authorities can be in parallel or in series. The authorizations can employ Boolean Logic and can be ANDed, ORed, or X-ORed together (or any other single or combinational logic or operation). In unknown environments, the user should be matched with the right approver through digital certificates. The approver can be a class or generic identity. For example, the approver can be any policeman with the right credential. Or, for training chess class or students on-line, the approver can be any person with Master Level credential.

In one embodiment, this can be applied to the workflow at work or job sites, where the approvers are at different levels: for example, 15 first-line managers, 2 second-line managers, and 1 general manager. Authentication can be done by PKI (public-private key pairs), biometrics (e.g. iris recognition, face recognition, signature recognition, or speaker recognition), password, smart card, credit card, magnetic card, RFID, active or passive device, memory stick, e-signature, digital certificate, license, token, bar code, passport, watermark (visible, invisible, video-based, picture-based, image-based, voice-based, music-based, or combination of them).

In one embodiment, authorization (centralized, distributed, or peer-to-peer) can be done on a fixed mechanism, or based on a dynamic rule. Licenses can be used for the rights assignment, transferring them, reassigning them, selling them, or distributing them. The system can be used for a situation where no money exchanges hands. The authorities can be delegated to other entities through certificates or licenses.

In one embodiment, voting mechanism can be used for authorization process. Majority or super-majority (much more than 50 percent) can be applied. One entity may have veto power, such as a parent with respect to the children. This can apply to employee-employer situation, as well as court-appointed power-of-attorney. The guardian can approve the whole package, or can approve item-by-item, based on the prior setting of the system.

In one embodiment, the decision or authorization is delayed for a period of time, for example, one week, to be reviewed again by the same user or other sub-users, to verify the intentions, or stop impulse decisions. Note that if the price is changed during that delay time period, the repeat approval becomes more relevant and useful.

Other applications of the system are for the persons who are subject to the approval of the trustee to spend money, either because of the court order or existence of a trust. This system enables that trustee (or somebody holding power-of-attorney) to manage the fiduciary duty, while allowing that person to make on-line purchases. This system provides a safe place to buy objects, goods, or services on the Internet for young children. This system also applies to a situation that an entity (a person or a company) under bankruptcy has to get approval from a third party before making a major purchase.

In one embodiment, there is an engine looking for patterns of activities to spot illegal or suspicious activities, to remove their power/authority, for the protection of users, or report them to police/FBI for further investigations.

In one embodiment, the users or subscribers can have a sub-user or approver register their credit card(s) as the primary source of funds for subscription fees and purchases. Thus, in that case, from a financial perspective, the account might be in the name of the sub-user, and the subscriber is the dependent entity on the account. This process can be used with minor children wishing to purchase on the web. Most of these teenagers do not have their own credit cards, but they could do the transactions using a dependent sub-user account (of a parent/guardian's account), if they do not possess their own credit card, PayPal account or other means of transferring funds.

In one embodiment, the same business process can be used to notify the parent that the child has gone shopping, and the parent needs to log into the account, review the shopping cart contents, and make a decision. There may also be a text box (or check boxes, radio boxes, or other entry form mechanism) where the parent can type in, for instance, why the answer was “no” (in a non-emotional way, for example), to stop the shopping process and cancel the purchase transaction, with a good reason for the child.

Alternatively, the teenager may have their own credit card, but may only be allowed, by either the site or their parents, to register the parent as a sub-user to oversee the account activity, before, during, or after purchases (or periodically, e.g. per day, week, or month). Sites like Amazon and PayPal can use this system to empower those who need parental approval (or are otherwise cannot join the e-commerce revolution), enjoy the benefits of Internet and e-commerce, in a controlled and safe way.

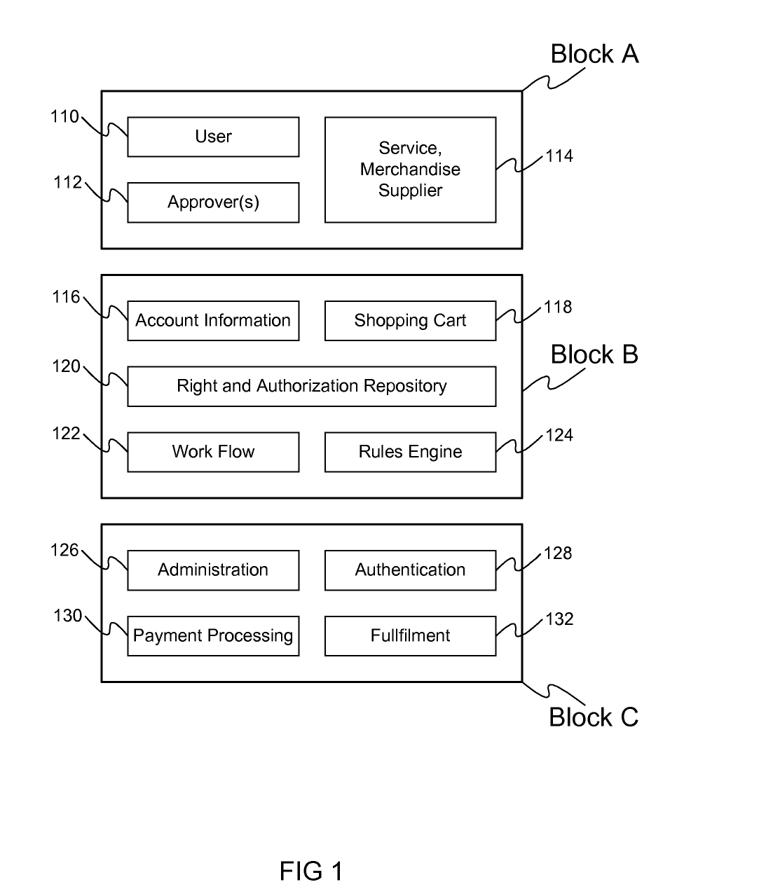

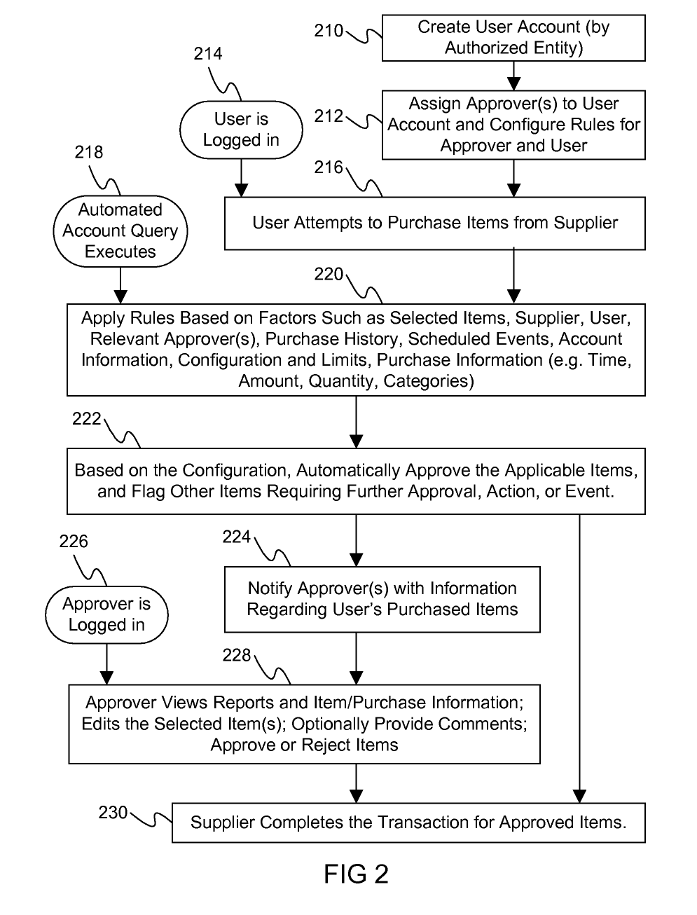

Two examples are shown in FIGS. 1-2: FIG. 1 shows a block diagram of a typical system (one embodiment/example). FIG. 2 shows a typical flow diagram of the typical method or process (one embodiment/example). The Figures are self-explanatory.

In one embodiment, the unique features include:

1. The user account at the e-commerce site is established with both the purchaser and authorizer registered together (if legally required, or otherwise because of the sites policy), in order for the purchaser to qualify to have an account.

2. Someone temporarily serving in the role of authorizer might not jointly register in the user account at the e-commerce site, but rather participate in an ad hoc type of purchasing event, where the purchaser is seeking a one-time action. For example, this would be a second opinion, such as when a spouse might seek a second opinion, before a purchase is consummated.

3. Considering the section 1 above to be the most common expression of the invention, the account would be established with the purchaser and authorizer bound together, such that the purchaser could not release the authorizer from his/her role without the site's permission, the authorizer's permission, or some entity with a higher authority. Such a situation (for example) might be when a minor child is allowed to establish an account at an e-commerce site, with their parent as the authorizer. The child could not later deactivate the parent's role, without the site's permission or parent's permission.

4. The most common expressions are those situations where the purchaser does not legally qualify for their own account at the site, and by having an authorizer who does qualify, they are then allowed to have an account.

5. This allows the purchaser to do everything a normal account holder would ordinarily do, such as shopping and placing intended purchases in the e-commerce shopping cart.

6. The purchaser's account could contain his or her own credit card or other form of payment data on record. Or, it could hold those same details for the authorizer's data, should the authorizer also serve as the payer for purchases made on the account. Or, alternatively, no payment data may be held on record.

7. Once a purchaser attempts to consummate a purchase, depending on the policy of the site, a particular stage in the process is reached, where the transaction cannot proceed further without the intervention of the authorizer. Most typically, this may be when the purchaser clicks the Submit button in the shopping cart. At this point, the purchaser may be alerted that the authorizer is being notified of the desired transaction.

8. The authorizer may be notified by any and all of the means, such as, but not limited to, email, SMS, mail, pager, and automated calling attendant. The authorizer may also be notified directly by the purchaser, to authorize, notify, or unlock the system. Purchaser and authorizer may have a pair of keys, which when they are combined, they produce a single key for authentication purposes, so that purchaser need the authorizer to do the transaction.

9. The authorizer must then respond to the request to authorize in order for the sale to be consummated. In most cases, authorization requires a login by the authorizer with the use of a password unknown to the purchaser.

10. Once logged in to the account at the site, the authorizer can evaluate the shopping cart contents in detail (although this information may have been passed along with the notification of needed authorization). The authorizer can then authorize, passively deny (fail to act), or actively deny the purchase, in whole or in part.

11. In the alternative to logging into the site, the authorizer might be allowed to send in a message, such as text messaging a code from their cell phone, to authorize or deny the purchase.

12. Should purchase be authorized, it likely then will proceed to be consummated in the usual fashion, at the given site, in the same manner, as when any normal purchaser clicks the “submit” button.

13. There may be options for the authorizer to list the reasons for the denial of authorization, using entry forms as text boxes, check boxes, or dropdown menus, enumerating common reasons. The reasons can then be forwarded back to the purchaser. This might prove a useful feature for parents who don't want to fight with their children over every detail, and may want to (in an unemotional manner) just inform them of the reasons behind their decision (to deny, or even, accept).

For example, one of the main features of this invention is: The parents can check the shopping cart, to approve/disapprove the content, with the box of explanation/feedback from the parents, explaining the reasons for denials or approvals. The system can keep a log or history of these denials and approvals. It can also find patterns, which indicate pattern of behaviors or potential problems.

In another embodiment, someone goes shopping (in an ad hoc scenario) and selects a button “Would you consider buying this for me?” (or choose it from a menu, or by any other means, as long as the result comes out that way), that would allow her/him to fill out a request and provide the contact information, such as email address, SMS cell number, etc, of a 2nd person, so that the e-commerce merchant can then reach out to that 2^{nd} person, as being requested to be the payer, by the first person. If that 2^{nd} person agrees to pay, then the second person pays, for example, by his/her credit card (or by other methods of payment), and the purchase for the first person is completed. Two or more people can also co-pay. Payments can also be done in installments, or according to a contract/agreement.

Any variation of the teachings above is also intended to be covered and protected by the current patent application.

1. A system of authorizing a transaction on a network or Internet, said system comprising:
a user; and
one or more approving agents corresponding to said user;
wherein said user initiates a transaction,
wherein said one or more approving agents approve or disapprove said transaction,
wherein said one or more approving agents and said user have a pre-existing relationship, and
wherein, in case of said disapproval of said transaction, said system terminates said transaction.

2. A system as recited in claim 1, wherein at least a message is sent to said user.

3. A system as recited in claim 1, wherein said system interacts with a network of one or more of the following: computer, Internet, router, cell phone, PDA, interactive devices, mobile devices, TV, mail, fax, or any digital, physical, or analog means of communication.

4. A system as recited in claim 1, wherein said user is one or more of the following: a patient, a child, a minor, an elderly, or somebody under the protection of a court or a guardian.

5. A system as recited in claim 1, wherein said one or more approving agents are one or more of the following: a parent, a nurse, a guardian, an attorney, trustee, someone with a power-of-attorney, a judge, a court, a family member, a sibling, a friend, an associate, or a grandchild.

6. A system as recited in claim 1, wherein said transaction involves buying one or more of the following: any tangible or intangible goods or services, furniture, appliances, music, books, movies, toys, opera tickets, sport event tickets, attorney pre-paid services, CPA pre-paid services, investment advice, stock purchase, or future stocks, items, contracts, or guarantees.

7. A system as recited in claim 1, wherein the structure of said one or more approving agents is hierarchical.

8. A system as recited in claim 1, wherein said system interacts with one or more of the following: a computer, cell phone, mobile device, electronic device, or PDA.

9. A system as recited in claim 1, wherein said system interacts with an e-commerce shopping cart.

10. A system as recited in claim 9, wherein said shopping cart is hierarchical.

11. A system as recited in claim 1, wherein said system interacts with different approval levels.

12. A system as recited in claim 1, wherein said system interacts with different classes of transactions.

13. A system as recited in claim 1, wherein said system interacts with one or more digital certificates or licenses.

14. A system as recited in claim 1, wherein said system assigns rights or authorities.

15. A system as recited in claim 1, wherein said system authenticates using one or more of the following: PKI, biometrics, iris recognition, face recognition, signature recognition, speaker recognition, password, smart card, credit card, magnetic card, RFID, active or passive device, memory stick, e-signature, digital certificate, license, token, bar code, passport, or watermark.

16. A system as recited in claim 1, wherein said system uses one or more of the following: logical operations on authorization, parallel authorization, authorization-in-series, position-based authorization, context-based authorization, centralized authorization, distributed authorization, authorization based on voting schemes, peer-to-peer authorization, or delayed authorization.

17. A system as recited in claim 1, wherein said system monitors activities or patterns.

18. A system as recited in claim 1, wherein at least a message is sent to said user using one or more of the following: an e-mail, mail, SMS, a signal on a pager, a text message on a cell phone, a message on the screen of a PC, a printout from a printer, a connection to the security alarm system, or calling multiple telephone numbers sequentially.

19. A system as recited in claim 1, wherein said system interacts with a centralized database or registry.

20. A system as recited in claim 1, wherein said system interacts with a credit card account, PayPal account, or any other methods of electronically transferring funds.
